(19) United States
(12) Patent Application Publication
(10) Pub. No.: US 2006/0287933 A1
(43) Pub. Date: Dec. 21, 2006

(54) Procedures for labeling wheels and putting them in storage

(76) Inventor: Gottfried Scholz, Hofheim-Langenhain (DE)

Correspondence Address: ROBERT W. BECKER & ASSOCIATES, 707 HIGHWAY 333, SUITE B, TIJERAS, NM, 87059-7507, US

(21) Appl. No.: 11/130,836

(22) Filed: May 17, 2005

(51) Int. Cl. G06Q 10/00

(52) U.S. Cl. 705/28

(57) ABSTRACT

A method for labeling and storing wheels as well as rims and tires of motor vehicles in storage racks, including accepting a wheel set and assigning to it an unambiguously defined identifier of a compartment of the storage rack, attaching a paste-on label at a visible place in the motor vehicle, and securing a tire tag to each wheel of the wheel set and rolling all of the wheels into the assigned compartment of the storage rack.

### BACKGROUND OF THE INVENTION

The invention relates to a procedure for labeling wheels as well as rims and tires of motor vehicles and putting them in storage in storage racks.

Storage of wheels as well as just tires and rims of a motor vehicle is always necessary when there is a change of season, e.g. from summer to winter or the other way around. It frequently happens that persons or companies do not have the space required for storing the wheel sets. With persons or companies with several or even a large number of motor vehicles it is then difficult to keep track of the wheel sets and the correspondence of each wheel set to its motor vehicle.

Service companies which deal with the storage or wheel sets of motor vehicles use paste-on labels for tires but these peel away in the course of time. When simple slips of paper to be pasted on or attached to label the wheels are used, these also frequently become detached or are interchanged. Other service providers use chalk to mark the tires, whereby the chalk blurs or fades after a while and the marks cannot be identified any more. Labeling tags attached to the valve of the tire are likewise not suitable because these are generally cut off from sight during storage.

Another problem is that of localizing the stored wheel sets. Wheel sets are usually simply put down someplace or placed in racks unsystematically. As a rule, there is no system for labeling and storing the wheel sets so they can be identified unambiguously and related to the customer at all times.

A more or less disordered labeling and storage of wheel sets of motor vehicles also leads to high administrative effort and high wage costs for the persons employed since a considerable expenditure of time is required to label and store the wheel sets.

The task of the invention is to devise a procedure for labeling and storing wheels as well as rims and tires of motor vehicles in storage racks which allows for rapid, unambiguous and clear administration of a large number of wheel sets to be put in storage.

### SUMMARY OF THE INVENTION

In accordance with the invention the task is solved through
acceptance of a wheel set and assignment to it of an unambiguously defined identifier of a compartment of the storage rack,
attachment of a paste-on label at a visible place in the motor vehicle and
securement of a front tire tag to each wheel and rolling of all the wheels into the assigned compartment of the storage rack.

This procedure is a simple, clear and time saving method for labeling and storing rims, tires and/or wheels of motor vehicles.

With an advantageous design of the procedure according to the invention, each wheel set is assigned a kit consisting of four front tire tags, namely one front tire tag for each wheel, four circular elastic rubber bands, namely one circular elastic rubber band for each wheel, and one paste-on label to be affixed on the motor vehicle.

Furthermore each front tire tag has printed on it at least the identifier of the compartment of the storage rack and an unambiguous identifier for the wheel and is secured to the wheel with a circular elastic rubber band.

Moreover the paste-on label has printed on it at least the identifier of the compartment of the storage rack and is affixed to a visible place in the motor vehicle.

In accordance with a further design of the invention at least the front tire tags are colored, with the color depending on the size of the tires.

So that storage of the wheel sets of the motor vehicle is very effective and space saving, each wheel set, in dependence on its tire size, is stored in a compartment of the storage rack that matches the size of the wheel set.

Finally, the customer specific and wheel specific data are collected and managed by means of a computer program.

First of all, the wheel set to be stored is assigned a compartment of a storage rack, say compartment number “213”. The compartment identifiers of the storage rack are plates which, for example, are attached to the front side of the rack floor. The plate displays, for example, the compartment identifier “213”. With that, all the compartments of the storage rack can be labeled systematically by being numbered consecutively.

Now the customer receives a kit consisting of four front tire tags, namely one tag for each wheel, four circular elastic rubber bands, namely one circular elastic rubber band for each wheel and one paste-on label to be affixed on the motor vehicle. With that this kit is assigned to the wheel set of the customer.

The front tire tags display the same identifier, namely compartment number “213”. In addition each front tire tag displays an identifier for its wheel, for example one of the abbreviations “FR” front/right, “FL”=front/left, “RR”=rear/right and “RL”=rear/left.

Furthermore the paste-on label displays at least the identifier “213” for the compartment of the storage rack and the name and address of the service company at which the wheel set is in storage.

In a simple, rapid and clear manner the numbered front tire tags are each secured with a circular elastic rubber band to the running tread of the appropriate wheel in the wheel set. The wheels of the wheel set are rolled into the storage rack compartment with the number indicated on the tags and stored. The customer receives the number on a paste-on label like a cloakroom ticket pasted visibly onto a door pillar in the interior of the motor vehicle.

With that the compartment identifier of the storage rack, the front tire tags and the paste-on label have an integrated, unique, unambiguous numbering system at the service company or other storage locations. Storage by the procedure according to the invention is also possible on the premises of the automobile drivers or in companies with a large fleet.

Wheels are stored without labels that peel away, without markings and without slips of paper yet they are fully protected from mix-ups with other wheels. A front tire tag is always visible on the running tread of each wheel and accompanies the wheel into the compartment of the storage rack. There are no mix-ups when wheels are washed or stored someplace else temporarily. At the motor vehicle's next change of wheels the customer receives with the paste-on label his wheel, tire or rims set and can have the wheels that have just been taken off placed in storage under the same identifying number.

Further clarity is rendered by a computer program which collects and manages all customer and wheel specific data.

In addition the plates for identifying the compartment of the storage rack, the front tire tags and the paste-on label can display the logo or company name of the manufacturer and possibly the name and address of the service company at which the wheel set is in storage. The latter information should always be given on the paste-on label so that the customer is informed of the storage location of his wheel set. It is also possible to include information such as tire tread depth and whether the hubcaps are in storage too.

The information on the plates and paste-on label can preferably be printed or engraved. The front tire tags and the plates of the storage rack compartments can be reused, for example, when the storage location is reorganized or if there is a change in customer or wheel set. The kit with the front tire tags, circular elastic rubber bands and paste-on label can be obtained by the service company from a central manufacturer, thus saving the service company time consuming work steps such as filling out data sheets and writing and printing paste-on labels and front tire tags.

Affixing front tire tags with circular elastic rubber bands is done very quickly and reliably. There are no repeat markings, say after tires are washed, for the identifiers on the tags withstand steam jets and washing machines. Many tire sets can be labeled, stored, and dispensed in a short time.

It goes without saying that the characteristics named above and still to be given below cannot just be used in the combinations indicated but also in other combinations.

### BRIEF DESCRIPTION OF THE DRAWINGS

The invention is explained more exactly in the following description which is based on an example of how it is applied. The example shows:

FIG. 1 a flow chart for the procedure according to the invention for labeling and storing wheels, rims and tires of motor vehicles in storage racks,

FIG. 2 a plate for labeling the compartment of a storage rack,

FIG. 3 a circular elastic rubber band for attaching a front tire tag to a wheel, a rim or a tire,

FIG. 4 a front tire tag to be attached to a wheel, a rim or a tire,

FIG. 5 a paste-on label to be affixed to a motor vehicle,

FIG. 6 an example for the labeling and storage of a wheel set of a certain tire size, and

FIG. 7 an example for the labeling and storage of a wheel set of a different, larger tire size.

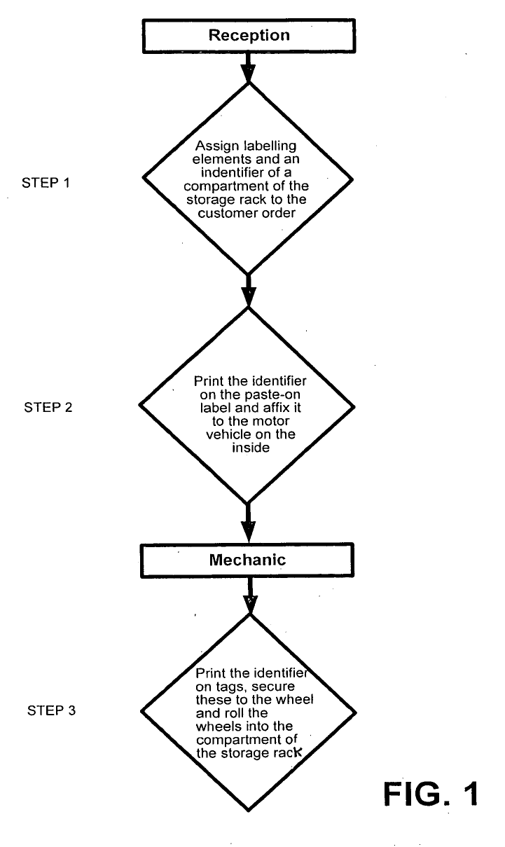

The procedure according to the algorithm shown in FIG. 1 is essentially characterized by three procedural steps.

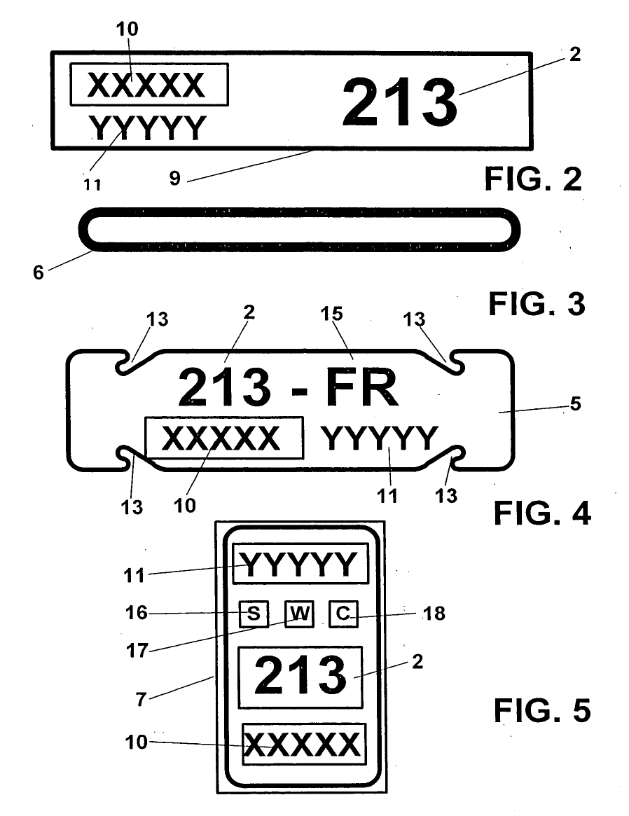

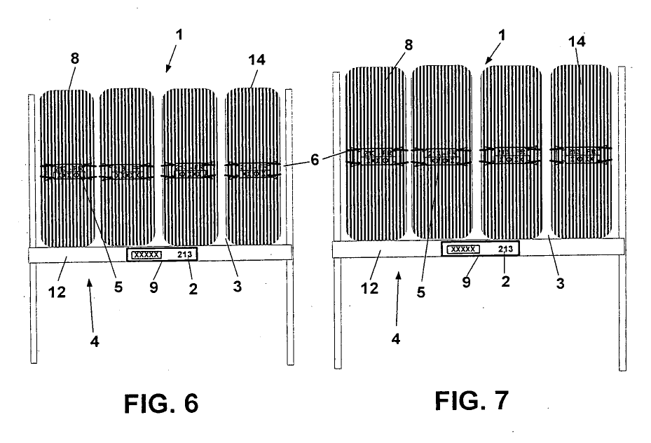

In the first step a wheel set 1 is accepted and an unambiguous identifier 2 of a compartment 3 of a storage rack 4 according to FIGS. 6 and 7 is assigned to it. The identifier 2 of the compartment 3 consists of an unambiguous number which occurs in the system only once, e.g. the number “213”. This number is assigned to the order from the customer. At the same time the wheel set 1 is assigned a kit of labeling elements which consists of four front tire tags 5 according to FIG. 4, four circular elastic rubber bands 6 according to FIG. 3 and a paste-on label 7.

In the second step the paste-on label 7 is affixed to a visible place in the motor vehicle, e.g. on the inner side of the door pillar of the motor vehicle.

In the third step a mechanic secures one front tire tag 5 to each wheel 8. Then all four wheels 8 of the wheel set 1 are rolled into the designated compartment 3 of the storage rack 4 and stored.

The rectangular plate 9 shown in FIG. 2 shows the identifier 2 and corresponds to the number of the compartment 3 of the storage rack 4. Furthermore, the plate 9 can have printed on it the company name of the manufacturer 10 and the company name and address of the service company 11. The plate 9 is attached to the front side of the rack floor 12 of the storage rack 4.

FIG. 3 shows a flexible circular elastic rubber band 6 for securing a front tire tag 5 to a wheel 8 or a rim or a tire, as this is to be seen in FIGS. 6 and 7.

FIG. 4 shows a rectangular front tire tag 5. It has four notches 13 near its left and right sides for reception of the circular elastic rubber band 6. One end of the circular elastic rubber band 6 is passed through an opening in the wheel 8, the circular elastic rubber band 6 is stretched and each end of it is slipped around one side of the front tire tag so that it slides into the two notches 13 on that side. The reverse side of the front tire tag 5 is pressed against the running tread 14 of the wheel with mounted tire 8 by the tension of the circular elastic rubber band 6.

Each front tire tag 5 has the identifier 2, namely the number “213”, printed on it. This number is that of the assigned compartment 3 of the storage rack 4 in which the tire or wheel set 1 is to be stored. In addition, an abbreviation 15 “FR”=front/right, the company name of the manufacturer 10 and the company name and address of the service company 11 are printed on it. Thus the front tire tag 5 is secured to the front right wheel. The front left tire and the right and left rear tires are marked accordingly.

The paste-on label 7 according to FIG. 5 likewise contains the identifier 2, namely the number “213” of the compartment 3 of the storage rack 4 as well as the logo or company name of the manufacturer 10 and the company name and address of the service company 11. Moreover the paste-on label 7 contains certain lettered squares which are marked by the service company as applicable. Square 16 is marked when the wheel set 1 consists of summer tires, square 17 is marked when it consists of winter tires, and square 18 is marked when the customer also wants the hubcaps to be stored.

The plate 9 and the front tire tags 5, at least, are of the color yellow for wheel sizes up to 225 but of the color silver for wheel sizes over 225. Of course, these and other colors can also be assigned to other wheel sizes.

FIGS. 6 and 7 show two examples of storage racks 4 which have compartments 3 of different sizes. The sizes of the compartments 3 depend on the wheel sets 1 to be stored. For example, a wheel set 1 of wheel size 225 or less is stored in the storage rack according to FIG. 6 and a wheel set 1 of wheel size greater than 225 is stored in the storage rack according to FIG. 7.

The present invention is, of course, in no way restricted to the specific disclosure of the specification and drawings, but also encompasses any modifications within the scope of the appended claims.

1. Method for labeling and storing wheels as well as rims and tires of motor vehicles in storage racks, comprising the steps of:
accepting a wheel set,
assigning to the wheel set an unambiguously defined identifier of a compartment of the storage rack,
attaching of a paste-on label at a visible location in the motor vehicle,
securing a tire tag to each wheel of the wheel set, and
rolling all of the wheels into the assigned compartment of the storage rack.

2. A method according to claim 1, wherein the rolling step comprises rolling all of the wheels into the assigned compartment such that the corresponding tire tag faces outwardly or toward the front.

3. A method according to claim 1, wherein each wheel set is assigned a kit comprising four tire tags, namely one tire tag for each wheel, four circular elastic rubber bands, namely one elastic rubber band for each wheel, and one paste-on label for affixing to the motor vehicle.

4. A method according to claim 1, wherein each tire tag has printed on it at least the identifier of the compartment of the storage rack, as well as an unambiguous identifier for that particular wheel, and wherein the tire tag is secured to the wheel with a circular elastic rubber band.

5. A method according to claim 1, wherein the paste-on label has printed on it at least the identifier of the compartment of the storage rack.

6. A method according to claim 1, wherein at least the tire tags are colored, and wherein the color is a function of the size of the tires.

7. A method according to claim 1, wherein each wheel set, as a function of its tire size, is stored in a compartment of the storage rack that matches the size of the wheel set.

8. A method according to claim 1, which includes the further step of collecting and managing customer specific and wheel specific data by means of a computer program.
